(19) United States
(12) Patent Application Publication
(10) Pub. No.: US 2002/0008344 A1
(43) Pub. Date: Jan. 24, 2002

(54) Angle vise jaw

(76) Inventor: Jerzy Iwanik, Sterling Heights, MI (US)

Correspondence Address: William M. Hanlon, Jr., Young & Basile, P.C., Suite 624, 3001 West Big Beaver Road, Troy, MI, 48084, US

(21) Appl. No.: 09/909,257

(22) Filed: Jul. 19, 2001

Related U.S. Application Data
(60) Provisional application No. 60/219,804, filed on Jul. 19, 2000.

(51) Int. Cl. B25B 1/24

(52) U.S. Cl. 269/277

(57) ABSTRACT

An angle vise includes a plate having a plurality of identical apertures spaced from one another and at least one pivot aperture. A pivot pin is engageable within the pivot aperture for rotatably supporting an arm having a pivot bore for receiving the pivot pin. The arm includes at least one surface spaced from the pivot bore, such that the at least one surface supportingly aligns with at least one of the plurality of identical apertures in the plate when the arm is rotated about the pivot pin to a predetermined angular orientation. Preferably, the combination of the plurality of identical apertures in the plate and the at least one surface on the arm are spaced relative to one another a predetermined distance to define at most a 1° incremental angular adjustment about the pivot pin for the rotatable arm. More preferably, the incremental angular adjustment is in the range of one-half (½°) to one degree (1°) of incremental angular adjustment inclusive about the pivot axis, and provides adjustment extending over an angular orientation between 0° and 45° inclusive.

### FIELD OF THE INVENTION

The present invention relates to an apparatus for accurately and rigidly supporting a workpiece in a selected position with respect to an operating tool while the workpiece is undergoing a machining operation, and more particularly, a vise jaw or plate formed with a plurality of apertures arranged in a predetermined pattern with reference to at least one pivot point, where sufficient apertures in the plate are provided for incremental angular adjustment with respect to the at least one pivot point in increments of at most 1° from 0° to 45°.

### BACKGROUND OF THE INVENTION

Workpiece positioning devices are known for supporting a workpiece in a selected position when the workpiece is undergoing a machining operation. Typically, the workpiece positioning device holds a workpiece firmly between relatively movable jaws of a machine tool vise. One workpiece positioning device discloses three parallel rows of spaced apertures which receive pins for supporting a workpiece vertically, horizontally, or in various angular positions. Another workpiece positioning device discloses two arcuate rows of apertures formed between three horizontally spaced rows of apertures. An additional short vertical row and a short horizontal row of apertures are formed in the plate between the arcuate rows. One arcuate row provides angles between 0° to 90° in 10° increments, while the second arcuate row provides angles between 5° to 85° in 10° increments. Three pins are employed in this configuration to engage any of the top and bottom rows of apertures and any selected one of the apertures in the two arcuate rows. The use of an enlarged head on one of the pins can provide angular adjustment in 1° increments of workpiece positioning at any angle between 0° to 90°.

### SUMMARY OF THE INVENTION

It would be desirable in the present invention to provide an angle vise jaw with sufficient individual apertures for providing 1° incremental angular adjustment between at least 0° and 45°. It is desirable in the present invention to eliminate the need to use, store, and maintain a set of pins having enlarged heads in order to provide the angular 1° increments previously provided in known workpiece positioning vises. Such enlarged head pins can easily be misplaced, lost, damaged, or otherwise unavailable when needed to adjust a workpiece vise jaw to the desired configuration.

The present invention is an angle vise jaw for use as part of a standard gauge set of gauge blocks, angle blocks, or the like. The invention uses one of a pair of standard vise jaws or plates in which the vise plate is adapted to be fixedly mounted on a machine table or surface. The movable plate is slidable by a hand crank or other automated drive into and out of engagement with a workpiece to hold the workpiece between the two plates or jaws. The vise plate is formed with a plurality of identical apertures arranged in a predetermined pattern with reference to at least one pivot point, and preferably to two different pivot points. A sufficient number of identical apertures are provided for incremental angular adjustment in ½° or 1° increments from 0° to 45°.

One of a set of different link bars, arms, or support members are pivotally mounted on the plate. Each support member has an aperture at one end for receiving a pivot pin for pivotally connecting the support member with respect to an axis extending through the coaxial bores receiving the pivot pin. The arm or support member has at least one surface adjacent an opposite end adapted to be supported on a locating pin which is insertable into one of the apertures in the plate. This configuration enables the arm to be pivoted about the pivot pin to any angle and then supported in the desired angle by the locating pin which supportingly engages the at least one surface on the support member and extends into one of the plurality of identical apertures in the plate. The upper surface of the arm acts as a support for the workpiece. An upper edge of the workpiece to be machined extends above the upper surface of the plate and is disposed at the desired angle.

Other objects, advantages and applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a side elevational view of a first part of an angle vise jaw having a plurality of identical apertures formed therein according to the present invention;

FIG. 2 is a side elevational view of the first part of an angle vise jaw according to the present invention with a first arm pivotally connected to the first part;

FIG. 3 is a side elevational view of the first part of an angle vise jaw according to the present invention with a second arm pivotally connected to the first part;

FIG. 4 is a side elevational view of a first part of an angle vise jaw according to the present invention with a third arm pivotally connected to the first part;

FIG. 5 is a simplified perspective view of an example of a vise jaw adapted to receive and engage the angle vise jaw according to the present invention for holding a workpiece in a predetermined angled orientation at a work station; and

FIG. 6 is a side elevational view of the angle vise jaw according to the present invention.

### DETAILED DESCRIPTION OF THE PREFERRED EMBODIMENT

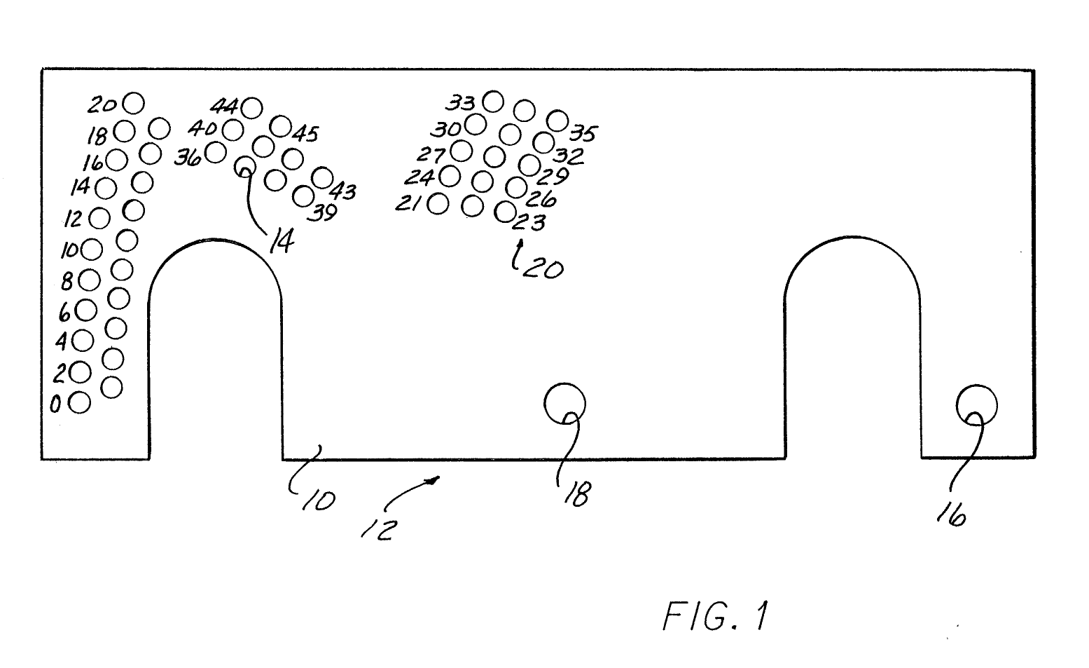

Referring now to FIG. 1, a first part or plate 10 of an angle vise jaw 12 includes a plurality of identical apertures 14 spaced from one another and at least one pivot aperture 16. Preferably, two pivot apertures 16, 18 are provided. The plurality of identical apertures 14 are arranged along circular arc segments centered with respect to at least one of the pivot apertures 16, 18. Concentric circular arc segments can be provided as required with adjacent apertures between the concentric arc segments offset from one another by at most a 1° incremental angle with respect to the central pivot axis of one of the pivot apertures 16, 18. The adjacent apertures 14 between concentric circular arc segments can be offset by a half degree (½°) incremental angle with respect to a central pivot axis of one of the pivot apertures 16, 18, if finer adjustment is desired. Indicia means 20 can optionally be provided for labeling at least some of the plurality of apertures 14 for identifying the angular position corresponding to the aperture with respect to the central pivot axis of one of the pivot apertures 16, 18. It can be seen clearly in FIG. 1, by way of example and not limitation, the illustrated plurality of apertures 14 correspond to angular adjustments between 0° and 45° in 1° increments.

Referring now to FIG. 2, a pivot pin 22 is engageable within one of the pivot apertures 16, 18. A support member or first arm 24 includes a pivot bore 24 for receiving the pivot pin 22. The first arm 24 includes at least one surface 28 corresponding to the radial distance from the central axis of rotation of the pivot pin 22 to the corresponding plurality of apertures 14 formed on the circular arc segments so that rotational movement of the first arm 24 about the pivot pin 22 brings the surface 28 in supportable alignment with one of the plurality of identical apertures 14 in incremental angular adjustments about the pivot pin 22. A locating pin 48 is insertable through the desired aperture 14 to hold the desired angular orientation. Preferably, the incremental angular adjustment is in a range of at most 1° increments, and more preferably, in one-half degree (½°) increments. The first arm 24 can include an L-shape defining an angled corner 30 for supporting a workpiece to be machined at a work station including the angle vise jaw 12. By way of example and not limitation, the illustrated configuration of FIG. 2 discloses a first arm 24 rotatable in 1° incremental angular adjustments from 0° to 20° inclusive with respect to the central axis of the pivot aperture 16.

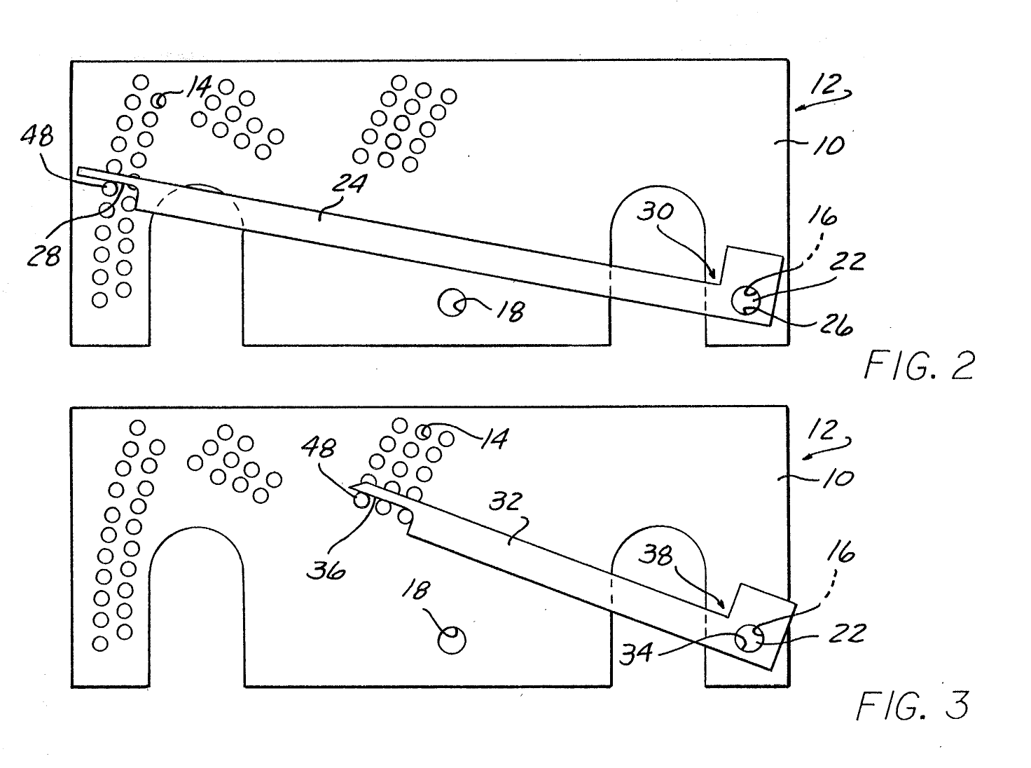

Referring now to FIG. 3, a support member or second arm 32 includes a pivot bore 34 for receiving the pivot pin 22 so that the second arm 32 can be rotated with respect to a central axis of pivot pin 22. The second arm 32 includes at least one surface 36, where the at least one surface 36 is supportingly alignable with at least one of the plurality of identical apertures 14 in the plate 10 when the second arm 32 is rotated about the pivot pin 22 to a predetermined angular orientation. A locating pin 48 can be inserted through the desired aperture 14 to hold the desired angular orientation. The at least one surface 36 is spaced from the central axis of the pivot pin 22 by a radial distance corresponding to the plurality of identical apertures 14 lying in the circular arc segments with respect to the pivot aperture 16. Pivotal movement of the second arm 32 about the central axis of pivot pin 22 results in the at least surface 36 supportingly aligning with at least one of the plurality of identical apertures 14 in the plate 10 in at most 1° incremental angular adjustments, and more preferably, in one-half degree (½°) incremental angular adjustments. The second arm 32 can include an L-shape defining an angled comer 38 for supporting a workpiece at a work station. By way of example and not limitation, the second arm 32 as illustrated in FIG. 3 provides 1° incremental angular adjustment about the pivot pin 22 between 21° and 35° inclusive with respect to the central axis of the pivot aperture 16.

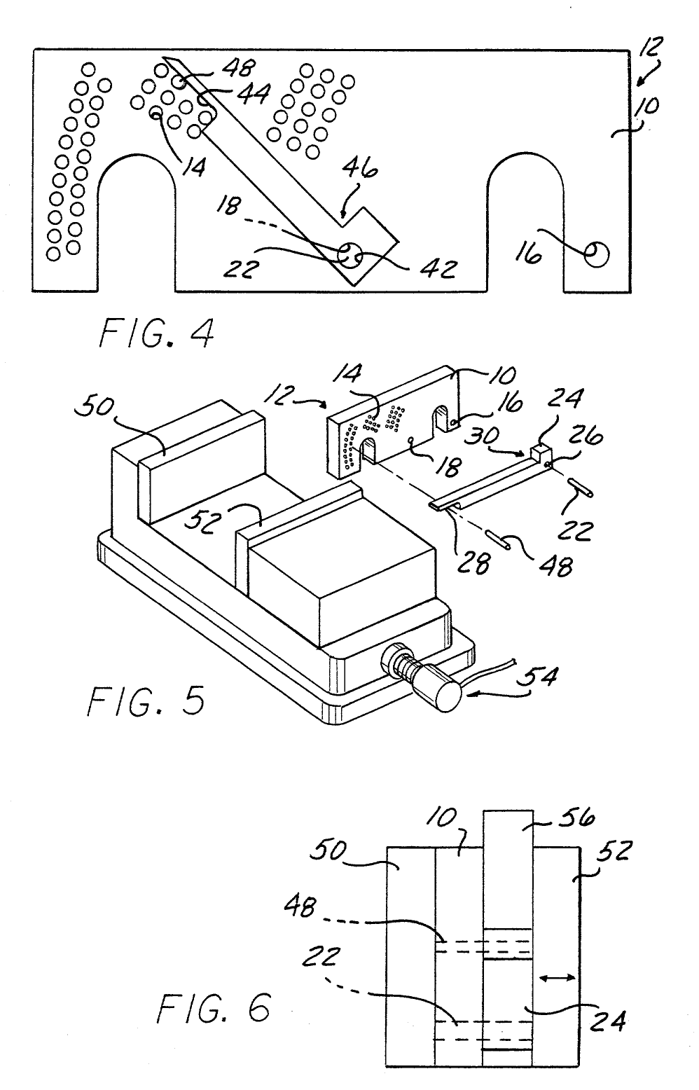

Referring now to FIG. 4, a support member or third arm 40 includes a pivot bore 42 for mounting the third arm 40 with respect to a central axis of the pivot pin 22 when engaged within the pivot aperture 18 of the plate 10. The third arm 40 includes at least one surface 44. The at least one surface 44 is spaced radially from the rotational axis of the third arm 40 by a distance corresponding to the plurality of identical apertures 14 lying along the circular arc segments with respect to the central axis of the pivot aperture 18 of the plate 10, so that at least one surface 44 supportingly aligns with at least one of the plurality of identical apertures 14 and the plate 10 when the third arm 40 is rotated about the pivot pin 22 to a predetermined angular orientation. Preferably, the at least one surface 44 in the third arm 40 is spaced to define at most a 1° incremental angular adjustment about the pivot pin 22 between supportingly alignment of corresponding identical apertures 14 in the plate 10 as the third arm 40 is rotated with respect to the central axis of the aperture 18. A locating pin 48 can be inserted through the desired aperture 14 to hold the desired angular orientation. The incremental angular adjustment can be in half degree (½°) increments for corresponding supportable alignment of apertures 14 and at least one surface 44, if finer adjustment is desired. The third arm 40 can include an L-shape to define an angled corner 46 for supporting a workpiece at a work station at a desired angular orientation for performing work thereon. By way of example and not limitation, the illustrated configuration of FIG. 4 discloses a third arm 40 rotatable in 1° incremental angular adjustments about the pivot pin 22 from 36° and 45° inclusive with respect to the central axis of pivot aperture 18 in the plate 10.

Referring now to FIG. 5, the angle vise jaw or tool according to the present invention is shown in perspective view with plate 10, support member 24, pivot pin 22, and locating pin 48 for placement in operative position on a machine vise jaw having a pair of relatively shiftable jaws 50, 52. The illustrated machine vise jaw includes a manual handle 54 for moving the jaws 50, 52 relative to one another. It should be understood that automated vise jaw movement is considered to be within the scope of the present invention as disclosed herein. The angle vise jaw 12 according to the present invention is adapted to be placed in an operative position between jaws 50, 52 so that a workpiece 56 can be supported in a desired angular orientation by the angle vise jaw 12 when held between the jaws 50, 52 as best seen in FIG. 6. The pivot pin 22 is operably engageable selectively in pivot aperture 16 or pivot aperture 18 of plate 10. The locating pin 48 is engageable with any of the plurality of identical apertures 14 in the plate 10 and supportingly engageable with at least one surface 28, 36, or 44 in the first arm 24, second arm 32, or third arm 40, respectively, when the surface is supportingly aligned with the desired aperture 14 in the selected angular orientation of the respective arm with respect to the central axis of the corresponding pivot aperture 16 or 18.

An angle vise jaw 12 according to the present invention is typically used as part of a standard gauge set of gauge blocks, angle blocks, or the like. The angle plate 10 is operably engageable with respect to one of a pair of standard vise jaws or plates 50, 52 adapted to be operably mounted on a machine table or surface. The movable jaw is slidable by operation of a hand crank or other automated drive into and out of engagement with a workpiece 56 to hold the workpiece between the two plates or jaws 50, 52. The angle vise jaw 12 according to the present invention is formed with a plurality of identical apertures 14 arranged in a predetermined pattern with reference to two different pivot points 16, 18 to provide incremental angular adjustment in a range between one-half degree (½°) and 1° increments for angles between 0° and 45° inclusive. One of a set of different length support members or arms 24, 32, 44 are pivotally mounted with respect to the plate 10. Each support member or arm 24, 32, 40 has a pivot bore 26, 34, 42 respectively at one end for receiving pivot pin 22 for pivoting the arm 24, 32, 40 respectively about an axis extending through one of the pivot apertures 16, 18 and the pivot pin 22. Each arm 24, 32, 40 has one or more surfaces 28, 36, 44 respectively at an opposite end from the corresponding pivot bores to be supported by a locating pin 48 which is insertable into one of the apertures 14 in the plate 10 when coaxially aligned therewith. This enables the arm 24, 32, 40 to be pivoted about the pin 22 to any angle and then supported in the desired angle by the locating pin 48 which extends into one of the apertures 14 in the plate 10. The upper surface of the arm 24, 32, or 40 acts as a support for the workpiece as best seen in FIG. 6. An upper edge of the workpiece 56 to be machined extends above the upper surface of the plate 10 and is disposed at the desired angle. For purposes of clarity, the plurality of identical apertures 14 in the plate 10 are not illustrated with hidden lines in FIG. 6.

What is claimed is:

1. An angle vise comprising:
a plate having a plurality of identical apertures spaced from one another and at least one pivot aperture;
a pivot pin engageable within the at least one pivot aperture;
a support member having a pivot bore for receiving the pivot pin and at least one surface operably connectable with respect to any one of the plurality of identical apertures in the plate when the support member is rotated about the pivot pin to a predetermined angular orientation.

2. The angle vise of claim 1 further comprising:
the plurality of identical apertures in the plate spaced from one another a predetermined distance to define at most a 1° incremental angular adjustment about the pivot pin for the support member.

3. The angle vise of claim 2 further comprising:
the at most b 1° incremental angular adjustment of the support member about the pivot pin extending over an angular orientation between 0° and 45°, inclusive.

4. The angle vise of claim 1 further comprising:
the plurality of identical apertures in the plate spaced from one another a predetermined distance to define a ½° incremental angular adjustment about the pivot pin for the support member.

5. The angle vise of claim 4 further comprising:
the at most 1° incremental angular adjustment of the support member about the pivot pin extending over an angular orientation between 0° and 45°, inclusive.

6. The angle vise of claim 1 further comprising:
the at least one pivot aperture in the plate including first and second pivot apertures in the plate; and
a plurality of support members having different lengths, each support member having at least one surface operably connectable with respect to any one of the plurality of identical apertures in the plate when pivotally mounted to a pivot pin in one of the first and second pivot apertures of the plate.

7. The angle vise of claim 6 wherein the plurality of support members further comprises:
a first arm pivotally mountable on the pivot pin when disposed in the first pivot aperture for pivoting movement with respect to the first pivot aperture through an angular range of 0° to 20° inclusive;
a second arm pivotally mountable on the pivot pin when disposed in the first pivot aperture for pivoting movement with respect to the first pivot aperture through an angular range of 21° to 35° inclusive; and
a third arm pivotally mountable on the pivot pin when disposed in the second pivot aperture for pivoting movement with respect to the second pivot aperture through an angular range of 36° to 45° inclusive.

8. The angle vise of claim 1 further comprising:
indicia means for identifying at least a portion of the plurality of identical apertures in the plate.

9. The angle vise of claim 8 wherein the indicia means corresponds to an angle formed corresponding to one particular aperture of the plurality of identical apertures in the plate with respect to a corresponding one of the at least one pivot apertures in the plate.

10. The angle vise of claim 1 further comprising:
a locating pin engageable through any one of the plurality of identical apertures in the plate to hold the support member in a desired angular orientation with respect to the plate by engagement with the at least one surface of the support member.

11. The angle vise of claim 1 further comprising:
the plurality of identical apertures in the plate disposed along circular arc segments centered on a central axis of the corresponding at least one pivot aperture in the plate.

12. An angle vise comprising:
at least one plate having a plurality of identical apertures spaced from one another and at least one pivot aperture;
a pivot pin engageable within the at least one pivot aperture; and
at least one support member having a pivot bore for receiving the pivot pin and at least one surface operably connectable with at least one of the plurality of identical apertures in the plate when the at least one support member is rotated about the pivot pin to a predetermined angular orientation.

13. The angle vise of claim 12 further comprising:
the plurality of identical apertures in the at least one plate spaced from one another a predetermined distance to define at most a 1° incremental angular adjustment about the pivot pin for the at least one support member.

14. The angle vise of claim 13 further comprising:
the at most 1° incremental angular adjustment of the at least one support member about the pivot pin extending over an angular orientation between 0° and 45°, inclusive.

15. The angle vise of claim 12 further comprising:
the plurality of identical apertures in the at least one plate spaced from one another a predetermined distance to define a ½° incremental angular adjustment about the pivot pin for the at least one support member.

16. The angle vise of claim 15 further comprising:
the at most 1° incremental angular adjustment of the at least one support member about the pivot pin extending over an angular orientation between 0° and 45°, inclusive.

17. The angle vise of claim 12 further comprising:
the at least one pivot aperture in the at least one plate including first and second pivot apertures in the at least one plate; and
the at least one support member including a plurality of support members having different lengths, each support member having at least one surface operably connectable with respect to any one of the plurality of identical apertures in the at least one plate when pivotally mounted to a pivot pin in one of the first and second pivot apertures of the at least one plate.

18. The angle vise of claim 17 wherein the plurality of support members further comprises:
a first arm pivotally mountable on the pivot pin when disposed in the first pivot aperture for pivoting movement with respect to the first pivot aperture through an angular range of 0° to 20° inclusive;
a second arm pivotally mountable on the pivot pin when disposed in the first pivot aperture for pivoting movement with respect to the first pivot aperture through an angular range of 21° to 35° inclusive; and
a third arm pivotally mountable on the pivot pin when disposed in the second pivot aperture for pivoting movement with respect to the second pivot aperture through an angular range of 36° to 45° inclusive.

19. The angle vise of claim 12 further comprising:
indicia means for identifying at least a portion of the plurality of identical apertures in the at least one plate.

20. The angle vise of claim 19 wherein the indicia means corresponds to an angle formed corresponding to one particular aperture of the plurality of identical apertures in the at least one plate with respect to a corresponding one of the at least one pivot apertures in the at least one plate.

21. The angle vise of claim 12 further comprising:
a locating pin engageable through any one of the plurality of identical apertures in the at least one plate to hold the at least one support member in a desired angular orientation with respect to the at least one plate by engagement with the at least one surface of the support member.

22. The angle vise of claim 12 further comprising:
the plurality of identical apertures in the at least one plate disposed along circular arc segments centered on a central axis of the corresponding at least one pivot aperture in the at least one plate.
